(19) United States
(12) Patent Application Publication
(10) Pub. No.: US 2009/0136708 A1
(43) Pub. Date: May 28, 2009

(54) Composite Structure Of Composite Substrate And Plastic Material

(76) Inventors: Chun-Ying Huang, Ping-Jen City (TW); Wei-Jen Chen, Chong-Li City (TW)

Correspondence Address: LIN & ASSOCIATES INTELLECTUAL PROPERTY, INC., P.O. BOX 2339, SARATOGA, CA, 95070-0339, US

(21) Appl. No.: 12/211,813

(22) Filed: Sep. 17, 2008

(30) Foreign Application Priority Data
Nov. 23, 2007 (TW) 096219834

(51) Int. Cl. B32B 5/12; B29C 67/00

(52) U.S. Cl. 428/113; 264/137

(57) ABSTRACT

A composite structure of a composite substrate and a plastic material is provided. The composite structure is fabricated by a method including the steps of: preparing a plurality of fiber layers weaved in different directions and laminating the fiber layers to configure a stack; soaking the stack in a resin, and drying the soaked stack to obtain a composite substrate; conducting a compression molding process to the composite substrate to achieve a predetermined shape; putting the compression molded composite substrate in a mold of a plastic injection molding machine; injecting a melting plastic material obtained from plastic particles melted by an extrusion machine into the mold, for combining with the composite substrate; and water cooling for hardening the combination, thus achieving a product of the composite structure.

### BACKGROUND OF THE INVENTION

1. Field of the Invention

The present invention relates generally to a composite structure of a composite substrate and a plastic material, and more particularly, to a composite structure adapted for simplifying processing process, saving production cost, and improving product quality.

2. The Prior Arts

Composite materials, which are usually featured with advantages such as light weight, strong structural strength, are now widely used in making housings of small electronic products, e.g., notebook computers, mobile phones, or personal digital assistants (PDAs), for replacing plastic housings or serving as enhancement structures of plastic housings.

Typically, conventional composite materials are produced by stacking many layers of fibers together and then configured by compression molding. However, such a method is mainly adapted for producing flat or slightly curved composite material plates, and is incapable of further configuring more sophisticated small structures, such as a frame, a boss, or a bezel. Conventionally, if it is desired to configure such a small structure on a composite substrate, a glue-dripping machine is often employed to provide glue for manually or automatically combining an injection molded plastic structure onto the composite substrate. These small structures are usually provided for being engaged to other 3C structural elements. Unfortunately, the method of gluing with the glue-dripping machine often leaves gaps between the composite substrate and the 3C structural elements after the gluing process. Further, the gluing process requires for many glue-dripping machines and staff, which is expansive and time consuming.

### SUMMARY OF THE INVENTION

A primary objective of the present invention is to provide a composite structure of a composite substrate and a plastic material. The composite substrate and the plastic material are combined together by injection molding, thus achieving an optimal bondability therebetween and can being adapted for mass production.

For achieving the foregoing objective, the present invention provides a method for fabricating a composite structure of a composite substrate and a plastic material. The method includes the steps of: preparing a plurality of fiber layers weaved in different directions and laminating the fiber layers to configure a stack; soaking the stack in a resin, and drying the soaked stack to obtain a composite substrate; conducting a compression molding process to the composite substrate to achieve a predetermined shape; putting the compression molded composite substrate in a mold of a plastic injection molding machine; injecting a melting plastic material obtained from plastic particles melted by an extrusion machine into the mold, for combining with the composite substrate; and water cooling for hardening the combination, thus achieving a product of the composite structure.

The configured structure can be used for structural housings of 3C products, such as housings of notebook computers, housings of mobile phones, housing of PDAs, or housings of other products.

Comparing with the conventional technology which combines a small structure onto a composite substrate by gluing, the present invention can advantageously prevent the small structure from undesired detachment from the composite substrate. Further, the small composite structure fabricated by the composite substrate and the plastic material is integral structure. Therefore, when the composite substrate is further assembled to another element of the 3C product, they can be equipped without occurrence of any gap therebetween, thus improving the appearance quality of the 3C product. The present invention is further adapted for mass production, thus saving production cost.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a perspective exploded view of a composite structure of a composite substrate and a plastic material according to an embodiment of the present invention;

FIG. 2 is a schematic view illustrating a process of compression molding conducted to the composite substrate according to an embodiment of the present invention;

FIG. 3 is a cross-sectional view of the compression molded composite substrate according to an embodiment of the present invention;

FIG. 4 is a cross-sectional view of the composite structure of the composite substrate and the plastic material according to an embodiment of the present invention;

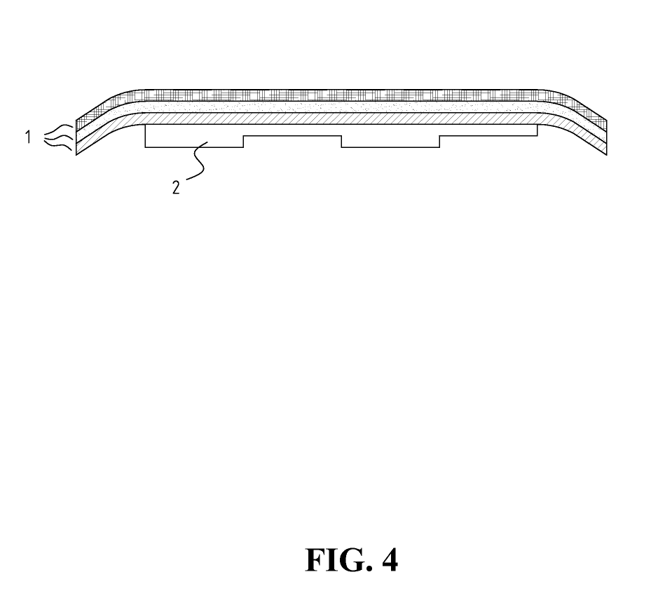

FIG. 5 is a schematic view illustrating an application of the composite structure of the composite substrate and the plastic material of the present invention for a housing of a notebook computer; and

FIG. 6 is a schematic view illustrating an application of the composite structure of the composite substrate and the plastic material of the present invention for a housing cover of a mobile phone.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

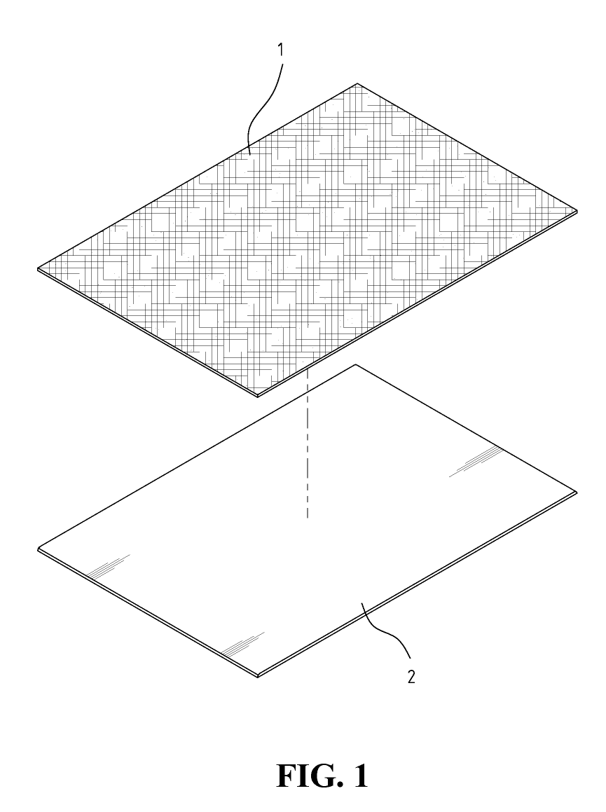

FIG. 1 is a perspective exploded view of a composite structure of a composite substrate and a plastic material according to an embodiment of the present invention. Referring to FIG. 1, there are shown a composite substrate 1 and a plastic material 2 combined together. The composite structure of the composite substrate 1 and the plastic material 2 is adapted for providing a solution of the difficulty that it is not easy to form a small structure on a composite substrate.

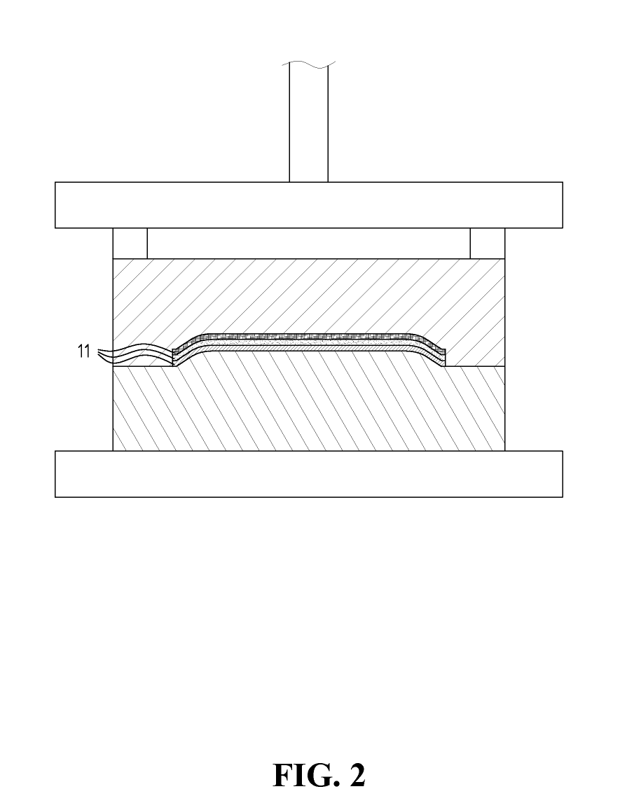

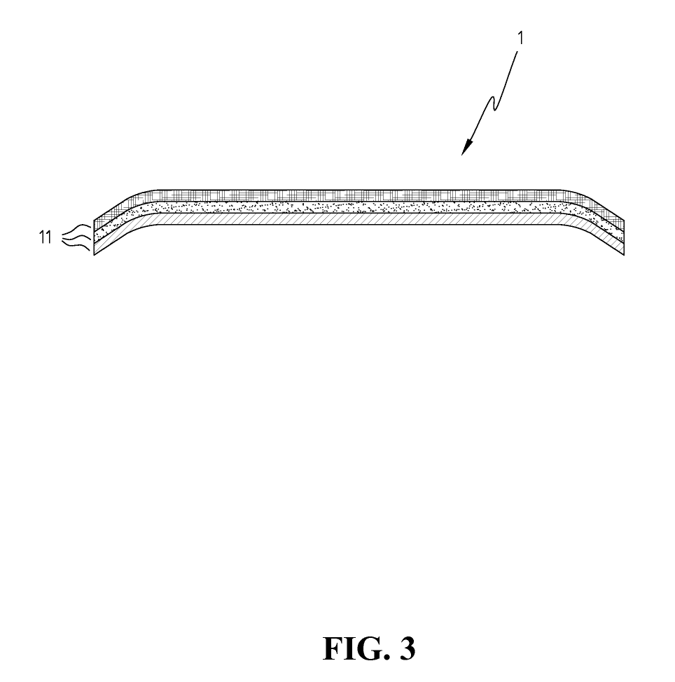

FIG. 2 is a schematic view illustrating a process of compression molding conducted to the composite substrate according to an embodiment of the present invention. FIG. 3 is a cross-sectional view of the compression molded composite substrate according to an embodiment of the present invention. Referring to FIGS. 2 and 3, the composite substrate 1 is obtained by several layers of fibers 11. These layers of fibers 11 are weaved along different directions, and then laminated to form a stack. The stack is then soaked in a resin. The resin can be either a thermoset epoxy resin, or a thermoplastic epoxy resin. After the resin is dried, the layers of fibers 11 are combined as a whole, thus configuring the composite substrate 1. The composite substrate 1 is then put in a mold of a compression molding machine, and is conducted with a compression molding process thereby to achieve a predetermined shape. The composite substrate 1 can be but is not restricted to be a glass fiber composite substrate, a Keveler fiber composite substrate, or a fiber weaved clothing. The stack is laminated with fiber layers weaved along different directions, for example can be a fiber weaved clothing laminated with a unidirectional fiber layer, a plane weave fiber layer, a basket weave fiber layer, and a multi-directional fiber layer one on another.

Referring to FIG. 1 again, the plastic layer 2 can be made from a plurality of thermoset or thermoplastic plastic particles, such as polyethylene (PE), polypropylene (PP), polystyrene (PS), polyvinyl chloride (PVC), polycarbonate (PC), acrylonitrile butadiene styrene (ABS).

The composite substrate 1 and the plastic material 2 are combined by the following steps. First, the preformed composited substrate 1 is put in a mold of a plastic injection molding machine. The mold is preheated to a temperature about 80 to 100° C. The plastic particles are melted by an extrusion machine into a melting plastic having a temperature about 200 to 210° C., and is injected into the mold with a relative high pressure. The composite substrate 1 and the plastic material 2 are combined each other therein. The combined composite substrate 1 and plastic material 2 are then cooled by water and hardened, thus a product of the composite structure can be obtained.

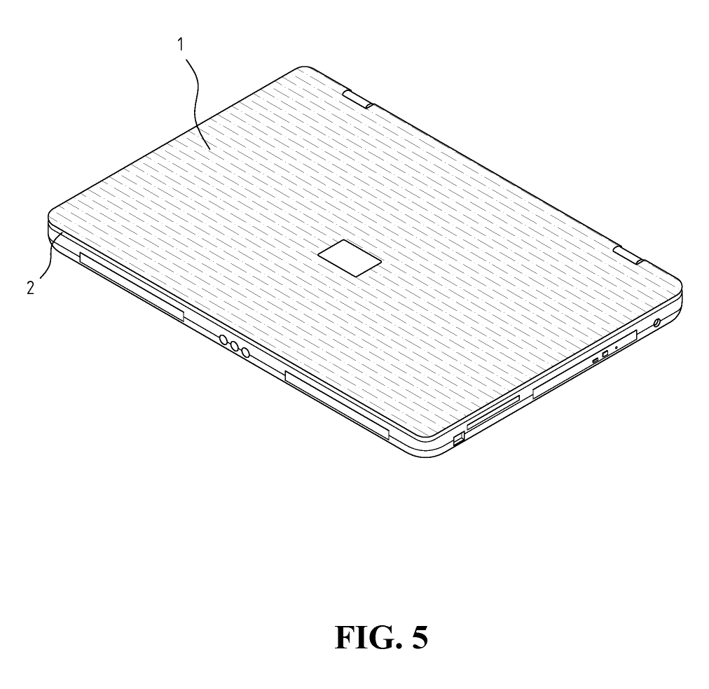

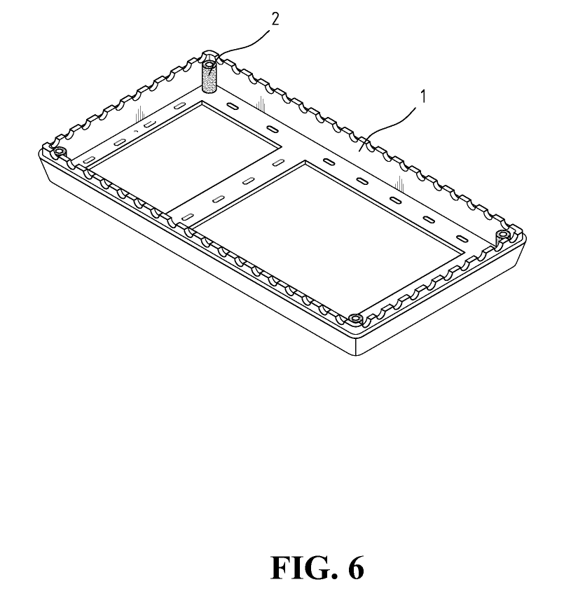

The present invention can be used for fabricating housings of current 3C products. FIG. 5 is a schematic view illustrating an application of the composite structure of the composite substrate and the plastic material of the present invention for a housing of a notebook computer. Referring to FIG. 5, it shows a cover made of the composite substrate 1 combining with a frame made of the plastic material 2 at a bottom surface of the cover. FIG. 6 is a schematic view illustrating an application of the composite structure of the composite substrate and the plastic material of the present invention for a housing cover of a mobile phone. Referring to FIG. 6, it shows a body of a mobile phone housing made of the composite substrate 1, combining with a plurality of poles having inner threads. The poles are made of injection molded plastic material 2.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A composite structure, comprising:
a composite substrate, having a predetermined shape, comprising a plurality of fiber layers laminated one on another, wherein the fiber layers are configured along different directions; and
a plastic material, having a predetermined shape and being combined at a surface of the composite substrate.

2. A method for fabricating a composite structure, comprising:
preparing a plurality of fiber layers weaved in different directions and laminating the fiber layers to configure a stack;
soaking the stack in a resin, and drying the soaked stack to obtain a composite substrate;
conducting a compression molding process to the composite substrate to achieve a predetermined shape;
putting the compression molded composite substrate in a mold of a plastic injection molding machine;
injecting a melting plastic material obtained from plastic particles melted by an extrusion machine into the mold, for combining with the composite substrate; and
water cooling for hardening the combination of the composite substrate and the plastic material.
